(19) United States
(12) Patent Application Publication
(10) Pub. No.: US 2009/0201432 A1
(43) Pub. Date: Aug. 13, 2009

(54) System and Method for Advertising in Retail Environments with Video Displays Attached to Shelving

(76) Inventors: James Hyde, Salt Lake City, UT (US); Bryce Englebrecht, Salt Lake City, UT (US); Michael Landon, Salt Lake City, UT (US); Craig Kelley, Salt Lake City, UT (US); Hugh Clark, Bountiful, UT (US)

Correspondence Address: KIRTON AND MCCONKIE, 60 EAST SOUTH TEMPLE,, SUITE 1800, SALT LAKE CITY, UT, 84111, US

(21) Appl. No.: 12/270,724

(22) Filed: Nov. 13, 2008

Related U.S. Application Data
(60) Provisional application No. 60/988,007, filed on Nov. 14, 2007.

(51) Int. Cl. H04N 5/64

(52) U.S. Cl. 348/836; 348/E05.128

(57) ABSTRACT

This application relates to systems and methods for advertising in retail environments through the use of video displays that are disposed on retail shelving near target products. In some instances, the video display system may comprise a head-end cabinet that is located remote to the video displays. The head-end cabinet may communicate with at least one tail-end box. In turn, each tail-end box may communicate with at least one line-driver box. The line-driver box may communicate with a fin box that sends signal to the video display. The video displays may be vertically and laterally located on the shelving to catch consumer attention and be easily circumnavigated. For example, the video displays may not be located in an end-of-aisle exclusion zone located at each end of a section of shelving. Similarly, no each video display in an aisle may be a minimum distance from another video display.

### RELATED APPLICATION

This application claims priority to U.S. Provisional Patent Application Ser. No. 60/988,007 filed Nov. 14, 2007 entitled, “System and Method for Advertising in Retail Environments with Video Displays Attached to Shelving.”

### FIELD

This application relates generally to systems and methods for advertising in retail environments. More specifically, this application relates to systems and methods for advertising in retail environments through the use of video displays that are strategically located on the front edge of shelves near target products.

### BACKGROUND

The importance of point-of-purchase advertising in retail environments that display items on shelves is well known in the art. Indeed, manufactures and merchants both employ a wide variety of advertising techniques to attract and entice consumers to purchase items that are stored and displayed on shelves. Because the shelf displaying or storing a product is often the last decision point in a buying decision, the ability to influence a consumer's last decisive moments before the consumer leaves the shelf often depends on the ability of the display to catch the consumer's attention.

Currently, there are several ways in which manufactures and merchants try to catch a consumer's attention at the point of purchase. For example, as a way to attract attention, some manufactures and merchants have placed static advertisements in close proximity to a target product, where a target product is a product for which the advertisements are used to increase sales. These static advertisements often rely on artistry, color, advertised price, shelf location, and/or the like to attract consumers. Although some of these static advertisements may be disposed flush with a shelf, some people have found that placing advertisements perpendicular to the shelving may be more effective at catching consumer's attention. In another example of how some current point-of-purchase advertising may try to catch consumer attention and influence sales, some have incorporated blinking lights with their otherwise static displays. However, in yet another example, some have placed video displays near the advertised product to catch attention and increase sales.

However, some of the current point-of-purchase advertising apparatus, systems, and methods may have some shortcomings. In one example of a shortcoming common to some retail-shelf point-of-purchase advertising, some video display point-of purchase advertising may lack hardware and components that can make advertising more effective and/or easier to maintain. For instance, some advertising displays may require batteries that must be replaced so that consumers can continue to view advertisements. However, in another example, some displays (i.e., video and static displays) may be placed in aisles in a manner that makes navigating the aisles more inconvenient. Similarly, in another example, some displays may become damaged or may even hurt a consumer if the consumer (or other object) should unintentionally strike the display. In still another example, some aisles may have too many displays or displays that are too close together. Such displays may tend to clutter an aisle and result in sub-optimal sales.

### SUMMARY

This application relates generally to systems and methods for advertising in retail environments. More specifically, this application relates to systems and methods for advertising in retail environments through the use of video displays that are mounted on shelves near target products. In some instances, the video display system may comprise a head-end cabinet that is located remote to the video displays. The head-end cabinet may communicate with a tail-end box that, in turn, may communicate with at least one line-driver box. The line-driver box may also communicate with a fin box that sends signal to the video display. In some embodiments, the tail-end box and/or line-driver box may comprise a line-driver device.

The video displays may be perpendicularly disposed at a front edge of retail shelving so the displays extend into the aisle. The video displays may also be located at eye level for a typical consumer. Moreover, the video displays may be laterally located on the shelving so that there is a minimum distance between any two video displays in an aisle. In one example, no two video displays in an aisle may be closer than about 28 feet. Similarly, the video displays may not be located within end-of-aisle exclusion zones that may be located on the ends of shelving sections. In one example, the video displays may not be located within about 8 feet of an end of an aisle.

### BRIEF DESCRIPTION OF THE DRAWINGS

The following description can be better understood in light of several Figures and a Table, in which:

FIG. 1 illustrates a representative computer device for use in association with at least some embodiments of the present invention;

FIG. 2 illustrates a representative computer network system for use in association with at least some embodiments of the present invention;

FIG. 3 illustrates a side view on one embodiment of a section of shelving with some components of a video display system;

FIG. 4 illustrates a side view of one embodiment of a video display;

FIG. 5 illustrates a top view of one embodiment of a section of shelving with some components of a video display system;

FIG. 6 illustrates a top view of one embodiment of a section of shelving with a video display, wherein the section of shelving has one target product disposed thereon;

FIG. 7 illustrates a top view of one embodiment of a section of shelving with a video display, wherein the section of shelving has one target product disposed thereon;

FIG. 8 illustrates a top view of one embodiment of a section of shelving with a video display, wherein the section of shelving has no target product disposed thereon;

FIG. 9 illustrates a top view of one embodiment of a section of shelving with multiple video displays, wherein the self section has one target product disposed thereon;

FIG. 10 illustrates a top view of one embodiment of a section of shelving with multiple video displays, wherein the self section has one target product disposed thereon;

FIG. 11a illustrates a top view of one embodiment of a section of shelving with a video display, wherein the section of shelving has no target product disposed thereon;

FIG. 11b illustrates a top view of one embodiment of a section of shelving with two video displays, wherein the section of shelving has no target product disposed thereon;

FIG. 11c illustrates a top view of one embodiment of a section of shelving with three video displays, wherein the section of shelving has no target product disposed thereon;

FIG. 12 illustrates a top view of one embodiment of an aisle wherein a first section of shelving comprises two video displays, and wherein the first section of shelving also has two target products disposed thereon;

FIG. 13 illustrates a top view of one embodiment of an aisle wherein a first section of shelving comprises three video displays and one target product, and wherein an opposing second section of shelving has another target product disposed thereon;

FIG. 14 illustrates a top view of one embodiment of a split aisle wherein a first section of shelving comprises a video display, and wherein a second section of shelving comprises two video displays;

FIG. 15 illustrates a top view of one embodiment of an aisle, wherein a first section of shelving comprises two video displays and a third video display is located near a perimeter in the retail environment; and

Table 1 shows some examples of nominal video display counts and channel prioritization.

The Figures and Table illustrate specific aspects of the video display system and associated methods for advertising. Together with the following description, the Figures and Table demonstrate and explain the principles of the video display system and associated methods. In the Figures, the thickness and configuration of components may be exaggerated for clarity. The same reference numerals in different Figures represent the same component.

### DETAILED DESCRIPTION

The following description supplies specific details in order to provide a thorough understanding. Nevertheless, the skilled artisan would understand that the video display system and associated methods can be implemented and used without employing these specific details. Indeed, the video display system and associated methods can be modified and used in conjunction with any apparatus, systems, components, methods, and/or techniques conventionally used in the industry.

The present invention relates to a system and method for advertising in retail environments, such as grocery stores, clothing stores, discount stores, and other businesses that display purchasable items on shelves. According to one embodiment of the present invention, the invention may include one or more video displays that may be disposed at the front edge of shelves in the retail environment. In some embodiments, the video displays may be pivotally connected and biased so as to extend into an aisle, substantially perpendicular to the front edge of the shelves. In such embodiments, the video displays may be bumped out of position and then return to their original position without being damaged.

According to some embodiments, the video displays may also be strategically located in aisles throughout the retail environment in a manner that may increase the sale of target products. Moreover, in some embodiments, the video displays may also be located in a manner that allows navigating aisles with video displays to be more convenient.

In some embodiments, the video display system may present content that may catch a consumer's attention and may help to increase sales. Although the video displays in the system may present any desired visual and/or audio content, some non-limiting examples of suitable content may include advertising information; discount and pricing information; program and preview messages; promotional campaigns; general information, such as news, traffic, and/or weather; video and/or audio streaming media; and/or near real-time footage of the consumer.

Additionally, in some embodiments, the content may be categorized into channels before being shown on the video display. As used herein, the term channels may refer to content that is targeted to, or meant to be shown near, a certain type of product. Some non-limiting examples of channels may include channels for carbonated soft drinks, isotonic drinks, water, salty snacks, cereal, cleaning products, health and beauty products, etc. According to some embodiments, some of the content in the channels may relate to target products. For example, Table 1 illustrates that some content of the carbonated soft drink channel may relate to DIET PEPSI®, that some content of the isotonic drink channel may relate to GATORADE®, and so forth.

After the content has been categorized into channels, the video displays may alternate between showing content from several channels. For example, video displays on a drink aisle may show a carbonated soft drink channel for a given period of time. Then, after showing content from the carbonated soft drink channel, the video displays in the drink aisle may show content from an isotonic drink channel for a period of time before returning to the carbonated soft drink channel and repeating the cycle.

### Exemplary Operating Environment

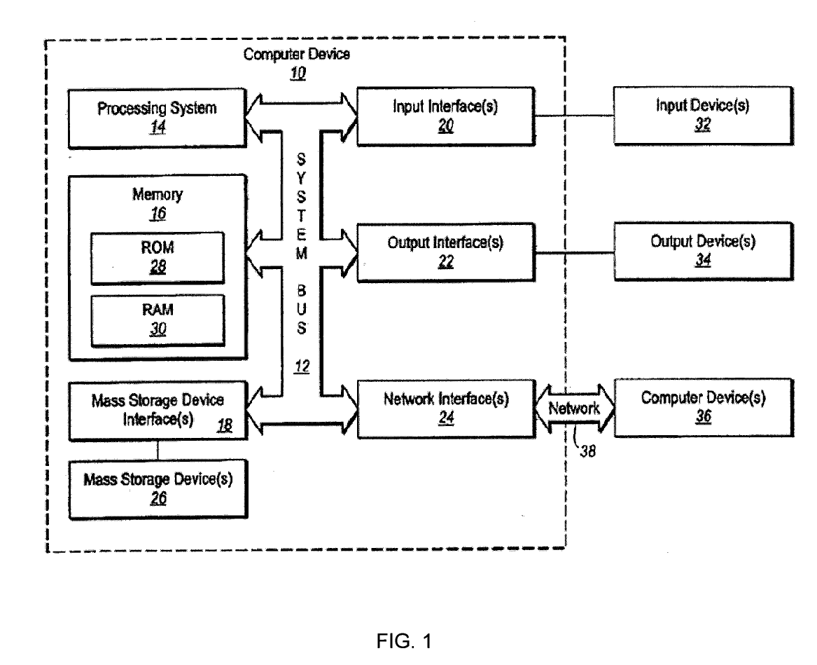

At least some embodiments of the present invention take place in association with one or more computer devices that are configured for utilization in association with providing a system for using video displays for point-of-purchase advertising in retail environments. Accordingly, FIG. 1 and the corresponding discussion are intended to provide a general description of a computer device. One skilled in the art will appreciate that the invention may be practiced by one or more computer devices and in a variety of configurations, including networked configurations.

Some embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, such as a receiver or other processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

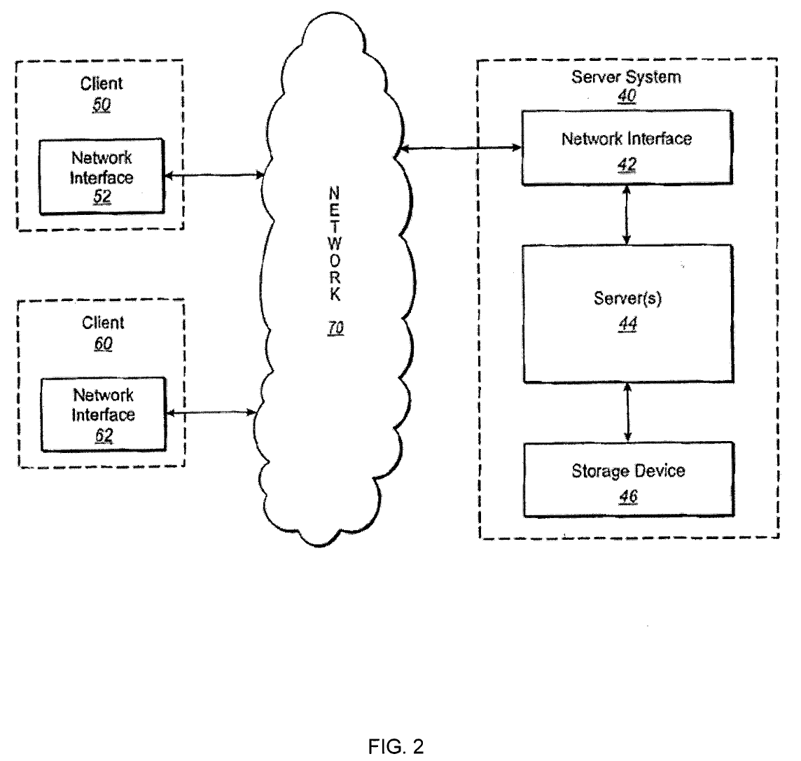

While those skilled in the art will appreciate that embodiments of the present invention may be practiced in a variety of computing environments with many types of computer system configurations, FIG. 2 provides a representative configuration that includes two clients connected to a server system. Those skilled in the art will appreciate that alternative embodiments include one client connected to a server system, more than two clients connected to a server system, a peer-to-peer system configuration, radio technology, satellite technology, a variety of computer media technology, and the like. Moreover, some embodiments in accordance with the present invention include a multitude of clients throughout the world connected to a network, where the network is a wide area network, such as the Internet.

As provided above, embodiments of the present invention take place in association with video displays and a video display system. By way of example, a system configuration is illustrated in FIG. 2 that includes a clearinghouse or server system 40 connected to clients 50 and 60 via a network 70, wherein client refers to any interaction with the video displays. Those skilled in the art will appreciate that network 70 may include a wide area network (e.g., the internet), a local area network, a leased line connection, a wireless network, a dial up connection, a satellite connection, a radio connection, and/or any other type of connection that enables information to be exchanged between system 40 and clients 50 and 60.

System 40, client 50, and client 60 each include a network interface (respectively illustrated as network interfaces 42, 52, and 62) that enables information to be exchanged or communicated. In the illustrated embodiment, system 40 also includes one or more servers 44 that selectively manage data, which is preserved at and/or obtained from a storage device 46.

### Exemplary Systems and Methods

According to some embodiments of the present invention, the invention may comprise a video display system including video displays that are disposed at the front edge of retail shelving. In order to provide a better understanding of the video display system and its associated methods for advertising in retail environments, the system is described below, followed by a description of how the video displays may be placed in a retail environment for optimal performance.

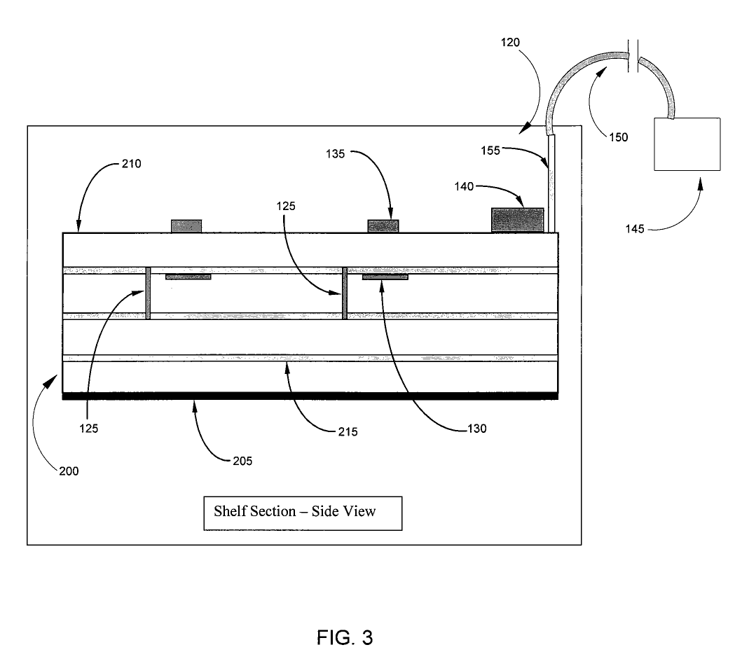

Accordingly, FIG. 3 illustrates some embodiments of the video display system 120 incorporated with a section of retail shelving 200. Specifically, FIG. 3 illustrates that, in some embodiments, the video display system 120 may comprise one or more video displays 125, fin boxes 130, line-driver boxes 135, tail-end boxes 140, head-end cabinets 145, power/data cables 150, and/or power/data poles 155. To better explain the retail shelving 200 and video display system 120, a more detailed description of the retail shelving 200 and components of the video display system 120 is given below.

The video display system 120 may be implemented with any known or novel retail shelving 200 that allows the video display 125 and other desired components of the video display system 120 to be disposed at the front edge of the shelving 200. One non-limiting example of such retail shelving 200 is gondola shelving, as is known in the art. Indeed, in some embodiments, the video display system 120 may used with any suitable variety of gondola shelving. By way of non-limiting example, some suitable varieties of gondola shelving may include double or single-sided sections, single and double-back wall sections, end sections, and the like.

Where the video display system 120 is used in conjunction with gondola shelving; a section of shelving 200 may have any desired characteristic. For instance, the shelving section 200 may be any suitable height, width, or length; be made from any suitable material; have any suitable component; or have any shape that is suitable for use with one or more video displays 125. In one example of a suitable shelf height, a standard gondola section of shelving may be about 6 feet tall, or taller. However, in another example, an over-the-counter (OTC) or half-height shelving section may be between about 4 and about 6 feet tall. As one example of suitable shelving components, FIG. 3 illustrates that a section of shelving 200 may comprise a base 205, a spine 210, and a plurality of shelves 215.

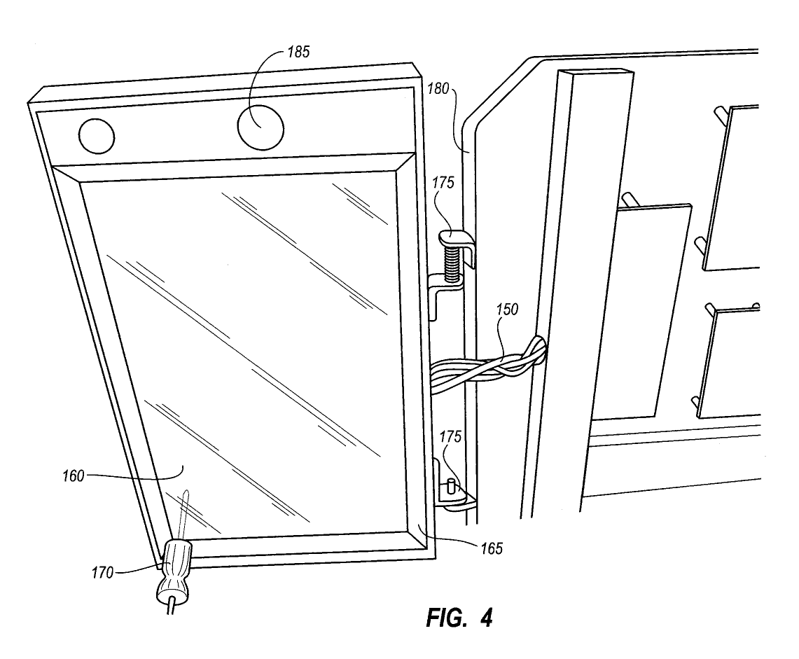

As mentioned, the video display system 120 may comprise one or more video displays 125 that may be located in aisles about the retail environment. Each video display 125 may comprise any known or novel type of video screen, such as a liquid crystal display (LCD) panel, a plasma display panel, a light-emitting diode (LED) display, a nano-emissive display (NED), and/or any other video screen suitable to be disposed on the front edge of shelving 200 and to show content to consumers. FIG. 4 illustrates that, in a typical embodiment, the video screen 160 of the video display 125 may comprise at least one LCD panel.

Additionally, in some embodiments, the video display 125 may comprise two video screens placed back to back (not shown in Figures). In such embodiments, a consumer who enters an aisle of shelving 200 from either direction may view content on the video display 125. Although not all video displays 125 in the video display system 120 need comprise back-to-back video screens, the term video display(s) is hereinafter used to refer to video displays 125 with the back-to-back configuration, unless otherwise stated.

The video display 125 may have any characteristic suitable for a video display 125 that is perpendicularly disposed at the front edge of shelving 200 in a retail environment. For example, the video display 125 may be any suitable size, shape, resolution, etc. In one example of video display 125 size, a video display 125 used with standard-height shelving 200 may have a diagonal screen size of about 15 inches. Similarly, a video display 125 with used with OTC shelving may have a diagonal screen size of about 12 inches. Nevertheless, the skilled artisan will recognize the video display 125 may be used video screens 160 that are larger or smaller than the exemplary sizes mentioned above. Furthermore, in addition to one or more video screens 160, the video display 125 may also comprise other suitable components. FIG. 4 shows that, according to some embodiments, the video display 125 may also comprise a protective covering 165, padding 170, a pivoting mechanism (e.g., hinges 175 and 175′), a connecting mechanism (e.g., bracket 180), and/or speakers 185.

Because the video display 125 may be implemented in areas with pedestrian traffic as well as in areas where objects, such as groceries, are continuously being moved, in some embodiments, the video display 125 may include a protective covering 165 that protects the display 125 from being scratched, smashed, broken, or otherwise damaged. The protective covering 165 may cover any desired part of the video display 125. Also, the covering 165 may be made from any material that may protect the display 125 while allowing the display 125 to present content. For example, FIG. 4 shows the video screen 160 may be covered with a transparent protective covering 165 made from a material such as polymethyl methacrylate (acrylic glass), a hard plastic, a tempered safety glass, etc.

In some embodiments, the video display 125 may also include padding 170 disposed about a portion or the entire perimeter of the display 125. This padding 170 may both serve to protect consumers who bump the video display 125 as well as reduce mechanical shock to the display 125. Any cushion-like material that serves to protect the display 125 and/or people from damage/injury from impact with the display 125 may be used as padding 170. For instance, the perimeter of the display 125 may be covered with foam, rubber padding, polychloroprene, nylon, fabric, batting, etc.

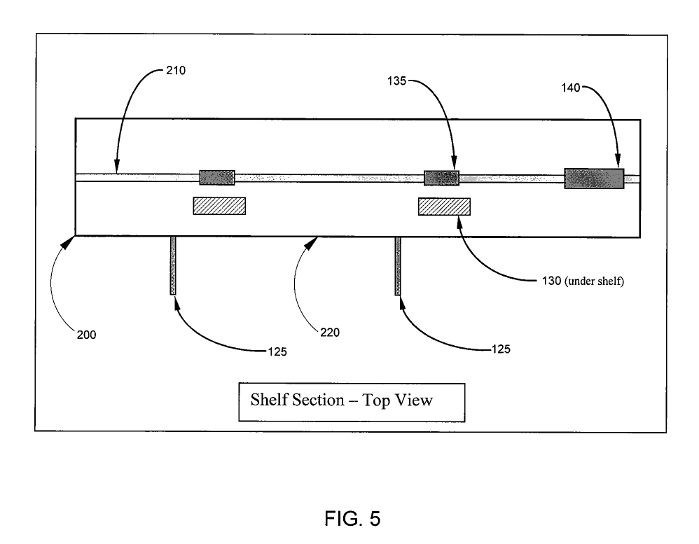

In some embodiments, the video display 125 may also comprise a pivoting mechanism that allows the video display 125 to pivot and swing under a deflective force. Moreover, in some embodiments, the pivoting mechanism may allow the display 125 to pivot towards and away from the shelving 200 so that in its default position, the display 125 is substantially perpendicular to the front edges 220 of the shelving 200, as illustrated in FIG. 5. Thus, the display 125 may stick out from the shelving 200 where it can be easily seen and where the content on the display 125 may be easily viewed. Additionally, because the display 125 may pivot, people and the display 125 may be further protected from damage and injury due to impact with the display 125. For example, if a consumer or merchant were to accidentally bump the video display 125, the display 125 may pivot in either direction so as to fold flat against the front edges 220 of the shelving 200 before returning to the original position.

Any mechanism that allows the video display 125 to pivot and/or swing towards the shelving 200 when a deflective force is applied to the display 125 may serve as the pivoting mechanism. Some non-limiting examples of a pivoting mechanism may include one or more hinges, resilient and/or flexible materials that allow the display to pivot, etc. Where the pivoting mechanism comprises one or more hinges (e.g., hinges 175 and 175′ in FIG. 4), any known or novel hinge may be used as long as the hinge is suitable to allow display 125 to pivot towards and away from the shelving 200 and also allows the display 125 to rest in a position that is substantially perpendicular to the front edge 220 of the shelving 200. Some non-limiting examples of such hinges may include, pintle hinges, J-bolt pivot hinges, barrel hinges, and spring gate hinges. For example, FIG. 4 illustrates the hinges 175 and 175′ may be pintle hinges. Moreover, the hinges (e.g., 175 an 175′) may be biased in any manner that allows the display 125 to rest in a position that is substantially perpendicular to the front edge 220 of the shelving 200. For example, example the hinges 175 and 175′ may be biased with springs, elastic materials, opposing cams, etc. FIG. 4 shows that, in some embodiments, the upper hinge 175 may be a spring loaded pintle hinge. That Figure also shows that, in some embodiments, the lower hinge 175′ may be a pintle hinge with opposing cam portions.

While one portion of the pivoting mechanism (e.g., hinges 175 and 175′) may be connected to the video display 125, another portion of the pivoting mechanism may also be connected to the shelving 200 through a connecting mechanism. The connecting mechanism may connect the video display 125 to any portion of the shelving 200 so that the display 125 is disposed at the front edge 220 of the shelving 200. For example, the connecting mechanism may be connected to the front edge 220 or to the spine 210 of the shelving 210. While the connecting mechanism may comprise any suitable components, some non-limiting examples of such components may comprise one or more brackets, mounts, clamps, or other components that may connect the pivoting mechanism to a desired portion the shelving 200. In one example, FIG. 4 shows the pivoting mechanism (e.g., hinges 175 and 175′) may be formed on or connected to a bracket 180 that, in turn, is connected to a desired part of the shelving 200. In this example, the bracket 180 may be modified or adjusted to connect the pivoting mechanism to shelving 200 with different configurations. In other examples, however, the pivoting mechanism may be directly connected to the front edges 220 of the shelves 200 via mounts, clamps, bolts, etc. (not shown in Figures).

In some embodiments, the video display 125 may be used in conjunction with speakers 185. Indeed, the video display 125 may be used with any suitable speaker or speakers that are disposed in any suitable location. For example, FIG. 4 shows the speakers 185 may be connected to the video display 125. However, in another example, the speakers 185 may be mounted in or hang from the ceiling or shelving 200.

FIG. 3 shows that, according to some embodiments, the video display system 120 may comprise a head-end cabinet 145 that is located remote to the video displays 125. For example, the head-end cabinet 145 may be placed in a store's equipment room, administration office, or in a location that is remote to the store. The head-end cabinet 145 may serve many purposes. For example, the head-end cabinet 145 may act as a server system that downloads content; selects or allows a system administrator to select content to be presented by the video displays 125; selects the amount of time various channels of content will be shown; selects speaker volume; or to otherwise controls the video displays 125. The head-end cabinet 145 may comprise any component that allows it to act as a server for the video displays 125. For example, the head-end cabinet 145 may comprise a conventional computer station with a central processing unit, and any other component that allows the head-end cabinet 145 to service a plurality of video displays 125.

The head-end cabinet 145 may send signal information to, or communicate with, the video displays 125 in any manner. For instance, the head-end cabinet 145 may send signal to the video displays 125 via cables or wirelessly, as discussed above. FIG. 3 illustrates, that where the head-end cabinet 145 sends signal to the video displays 125 and/or other components of the video display system 120 via data cables 150 (e.g., cat-5 cables), data and/or power cabling 150 may optionally pass through a power/data pole 155. The power/data pole 155 may substantially extend between the shelving 200 and the ceiling. Accordingly, the power/data pole 155 may serve to organize cables (e.g., 150) and be aesthetically pleasing.

In some embodiments, each section of shelving 200 that comprises one or more video displays 125 may also comprise one or more tail-end boxes 140 that may receive signal from and/or communicate with the head-end box 145. The tail-end box 140 may serve many functions, including pushing signal information received from the head-end cabinet 145 to one or more line-driver boxes 135, described below. Also, the tail-end box 140 may be disposed many suitable locations. For example, FIGS. 3 and 5 show the tail-end box 140 may be located at the spine 210 of the shelving 200.

The tail-end box 140 may include any suitable component that allows the tail-end box 140 to push signal information to the line-driver box 135. Some non-limiting examples of suitable components may include a computer, a line-driver device, an audio receiver, a transmitter, and/or a conventional power strip. Indeed, the tail-end box 140 may comprise any suitable computer, such as a Thin Client renderer, as is known in the art. One example of a suitable Thin Client renderer is the HP ThinClient® renderer, which is a solid-state computer that may render media files, such as MPEG files, into video and audio.

As mentioned, the tail-end box 140 may also comprise a line-driver device. The line-driver device may serve many purposes. For example, the line-driver device may split out digital audio and Ethernet from a standard cat-5 cable. In another example, the line-driver may serve as a small Ethernet switch or multi-port hub. In still another example, the line-driver may serve to amplify audio. The line-driver device may comprise any component that allows it to accomplish one or more of the aforementioned purposes.

Also, in some embodiments, the tail-end box 140 may also comprise an audio receiver. For instance, the tail-end box 140 may comprise any known or novel digital audio receiver that can interpret digital audio that has been transmitted over a cat-5 cable. One preferred example of such an audio receiver is the BEACON TECHNOLOGY® digital audio receiver.

According to some embodiments, the tail-end box 140 may comprise a transmitter. The transmitter may take video and audio output from the computer (e.g., Thin Client renderer) and transmit those outputs to the line-diver box 135, described below, through any suitable method of transmission (e.g., cat-5 cable). Indeed, in a preferred embodiment, the tail-end box 140 may comprise the MAGENTA UTX® transmitter.

FIGS. 3 and 5 illustrate that, in some embodiments, the video display system 120 may comprise a line-driver box 135 for each video display 125. The line-driver box 135 may receive signal from the tail-end box 140 and may serve many other purposes. For example, the line-driver box 135 may route signal and low-power information from the tail-end box 140 to a fin box 130, which is described below. The line-driver box 135 may comprise any suitable component, such as the aforementioned line-driver device, a conventional AC power transformer for the fin box 130, a conventional power strip, and/or a receiver. Although the line-driver box 135 may comprise any receiver that can receive and interpret the signal sent from the tail-end box 140. In a preferred embodiment, the line-driver box 135 for back-to-back video screen 160 video displays 125 may be the MAGENTA® K1500 TDC receiver. Similarly, the preferred receiver for single video screen 160 video displays may be the MAGENTA® K1500 TD receiver.

FIGS. 3 and 5 illustrate that, in some embodiments, the video display system 120 may also comprise one or more fin box 130. Moreover, in some embodiments, the video display system 120 may comprise one fin box 130 for every video display 125. The fin box 130 may serve many purposes. For instance, the fin box 130 may push signal to a corresponding video display 125. Moreover, the fin box may comprise any suitable component.

Additionally, the fin box 130 may be disposed in any location suitable to allow the fin box 130 to push signal to a corresponding video display 125. For example, FIGS. 3 and 5 illustrate that the fin boxes 130 may be located on the underside of a shelf 215, near the corresponding video display 125. Moreover, while the fin box 130 may be disposed at any suitable distance from a corresponding video display 125, in some embodiments, a fin box 130 may be disposed within about 100 feet of the video display 125. In other embodiments, the fin box 130 may be disposed within about 3 feet of the corresponding video display 125. Indeed, in a typical embodiment, the fin box 130 may be disposed within about 18 inches from the corresponding video display 125.

In addition to the previously mentioned components, the video display system 120 may comprise any other suitable component. For example, in some embodiments, the video display 125 may comprise a touch screen, a motion detector, a video camera, an audio recorder, a sleep circuit, a printer, and/or other components that may improve the effectiveness of the video display system 120.

The placement of the video displays 125 in the retail environment may play an important role in the effectiveness of the video display system 120. In one example, proper video display 125 placement may call more attention to target products. In another example, proper display 125 placement may make it easy for a consumer to view content. In still another example, proper display 125 placement may make navigating aisles more convenient. Accordingly, several embodiments of proper video display 125 placement are described below.

The video displays 125 may be disposed on the front edge 220 of a section of shelving 200 at any vertical height that may attract consumer's attention to or near a target product. Preferably, the video displays 125 should be positioned at a typical consumer's eye level. For example, in some embodiments, the lower edge of the displays 125 may be located between about 5 feet and about 5 feet 5 inches from the floor. However, one of skill in the art will recognize that the precise vertical positioning of the video displays 125 may depend on the arrangement individual sections of shelving 200.

The lateral placement of the video displays 125 within an aisle may be determined using several video display lateral placement parameters. For instance, the lateral placement of the video displays 125 may be determined using an end-of-aisle exclusion zone X, a minimum video display distance Y, a target product position range Z, and/or a nominal video display count, as are described below.

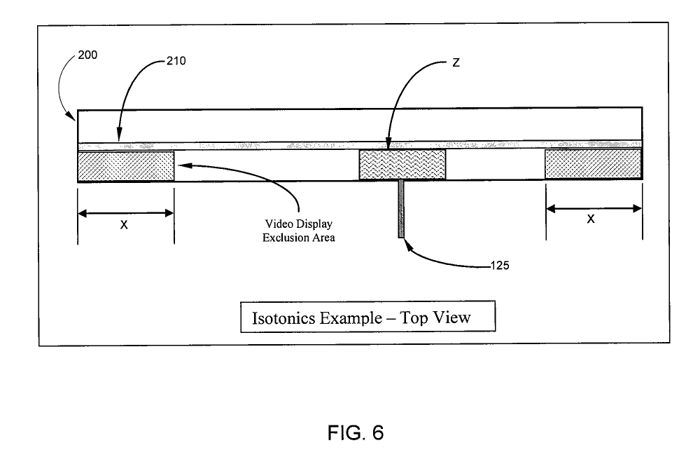

FIGS. 6-8 illustrate that the end-of-aisle exclusion zone X may refer to the maximum distance between the end of the aisle or section of shelving 200 and the nearest video display 125. This exclusion zone X may place the video display 125 in a position that attracts consumers into an aisle. Additionally the exclusion zone X may help to prevent consumers from bumping into the video display 125 when turning into an aisle. In one embodiment, the end-of-aisle exclusion zone X may be approximately 3 feet. However, other embodiments, the end-of-aisle exclusion zone X may be approximately 15 feet, 20 feet, 30 feet, 50 feet or 100 feet. Nevertheless, in a typical embodiment, the end-of-aisle exclusion zone X may be approximately 8 feet. Accordingly, the minimum aisle length that allows a video display 125 not to be located in either end-of-aisle exclusion zone X is a distance of 2X. Hence, in one example, where the end-of-aisle exclusion zone X is about 8 feet, the minimum aisle length for a single video display 125 may be about 16 feet. However, in cases where the section of shelving 200 is shorter than the minimum aisle length, such as may be the case with many OTC shelving sections, a single video display 125 may be placed as near the center of the length of the shelving 200 as possible, while respecting the target product considerations that are described below.

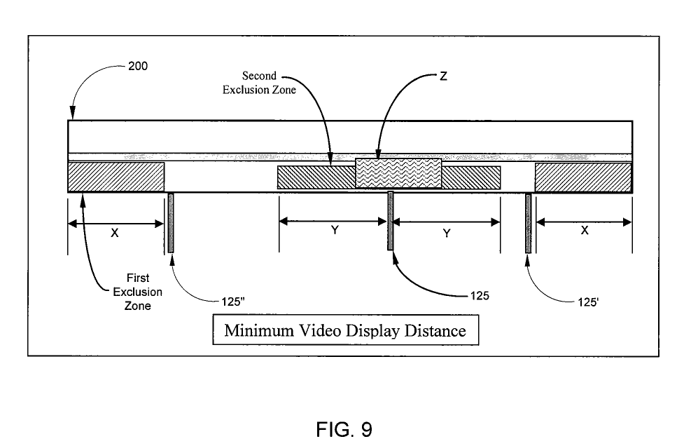

FIG. 9 shows the minimum video display distance Y may refer to the minimum distance between any two neighboring video displays 125. The minimum video display distance Y may prevent aisle from becoming too crowded with video displays 125 and may prevent video displays 125 from detrimentally competing for consumer attention. In some embodiments, the minimum video display distance Y may be about 50 feet. Nonetheless, in other embodiments, the minimum video display distance Y may be about 10 feet, 20 feet, 30 feet, 40 feet, 60 feet, 70 feet, 80 feet, 90 feet or 100 feet. Indeed, in a typical embodiment, the minimum video display distance may be about 28 feet. Using the minimum video display distance Y and the end-of-aisle exclusion zone X, the minimum length of a section of shelving 200 with 2 video displays 125 may be determined as 2X+Y. For example, where the end-of-aisle exclusion zone X is about 8 feet and the minimum video display distance Y is about 28 feet, the minimum length of a section of shelving 200 with 2 video displays 125 may be about 44 feet. Similarly, the minimum length of a section of shelving 200 with 3 video displays may be determined as 2X+2Y. For example, where the end-of-aisle exclusion zone X is about 8 feet and the minimum video display distance Y is about 28 feet, the minimum length of a section of shelving 200 with 3 video displays 125 may be about 72 feet.

FIG. 6 illustrates the target product position range Z may refer to the area of shelf space that is occupied by the target product, both of which are depicted as Z. As a general rule concerning video display 125 placement and the target product position range Z, the video display 125 may be placed on a section of shelving 200 containing the target product, or on a section of shelving 200 that is located opposite to the target product, as near as possible to the midpoint of the target product position range Z. Nevertheless, in some embodiments, video display 125 placement may vary from the midpoint of the target product position range Z in order to comply with the end-of-aisle exclusion zone X and the minimum video display distance Y parameters.

Each target product position range Z and/or content channel (described above) may be placed in priority from a highest to a lowest priority. This priority list may be used to place multiple video displays 125 in aisles with multiple target products, as is shown hereafter. Additionally, this priority list may organize backup channels that may be shown if a specific target product is missing from an aisle. The prioritization may be done in any suitable manner and may be based upon any desired characteristics. For example, prioritization may be based upon product popularity, or product price. Table 1 provides one example of a priority list for several different channels and some examples of corresponding target products. For instance, Table 1 shows that carbonated soft drinks may be given top priority, followed by isotonic drinks, water, salty snacks, cereal, cleaning products, and that health and beauty products may be given the lowest priority.

The nominal video display count parameter may be the lowest desirable number of video displays 125 that may be used to effectively advertise a certain channel. The nominal video display count may be determined by many factors, including the number of different target product types that relate to a channel, the spacing of the target products relating to a channel, the location of the target products relating to a channel.

Table 1 shows several examples of nominal video display counts for a variety of channels and their corresponding target products. For example, Table 1 shows the nominal video display count for the isotonic drink, water, and cleaning product channels may be 1 video display 125. Table 1 also shows that, in some embodiments, the health and beauty product channel may have a nominal video display count of 2 video displays 125. Furthermore, Table 1 shows that, in some embodiments, the carbonated soft drink, salty snacks, and cereal channels may have a nominal video display count of 2 or 3 video displays 125, depending on the size of the store and the range of products offered. By way of example of how the nominal video display count for a channel may vary depending on store size, in stores that are larger than about 37,000 square feet, the nominal video display count for the carbonated soft drink and salty snack channels may be 3. However, in this example, where stores are smaller than about 37,000 square feet, the nominal video display count for the carbonated soft drink and salty snack channels may be 2. Also, by way of example of how the nominal video display count may vary depending on the range of products offered, the cereal channel may include a third nominal video display 125 where the cookies and crackers products appear on an aisle separate from the ready-to-eat cereal products. In this example, two nominal video displays 125 may be placed in the ready-to-eat cereal aisle, and the third nominal video display 125 may be placed in the separate aisle for the cookies and crackers products.

### EXAMPLES

In order to illustrate how the aforementioned video display lateral placement parameters may be implemented in a typical retail environment, several non-limiting examples of the parameter's application are given below. Specifically, the examples provided below relate to sections of shelving 200 with single video display 125 embodiments, multiple video display embodiments, combination aisle embodiments, split aisle embodiments, and perimeter video display embodiments.

FIG. 6 depicts a top view of a section of shelving 200 comprising a single video display 125. Further, FIG. 6 also illustrates the application of the lateral placement parameters where a single target product is not located within either end-of-aisle exclusion zone X. In this example, because the target product position range Z falls completely between the two end-of-aisle limits X, the single video display 125 may be placed at a midpoint of the target product position range Z.

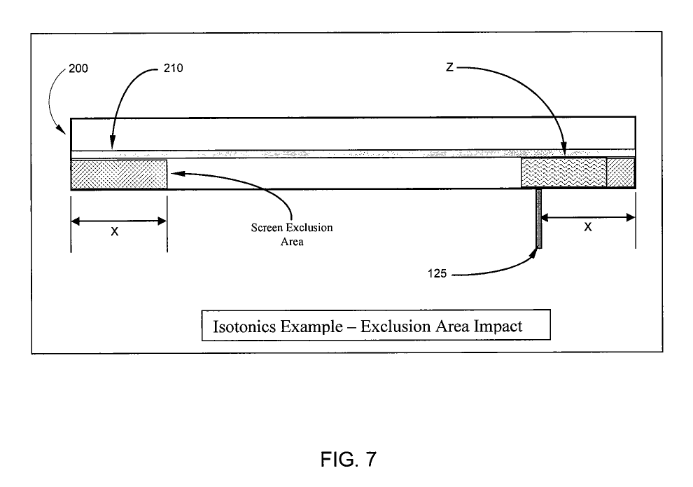

In another example of the application of the video display lateral placement parameters, FIG. 7 illustrates a top view of a section of shelving 200 comprising a single video display 125, where a single target product and target product position range Z falls partially within the end-of-aisle exclusion zone X of one end of the section. FIG. 7 shows, that in such circumstances, the video display 125 may be located as close to the center of the target product position range Z as is possible, while still keeping the display 125 outside the end-of-aisle exclusion zone X.

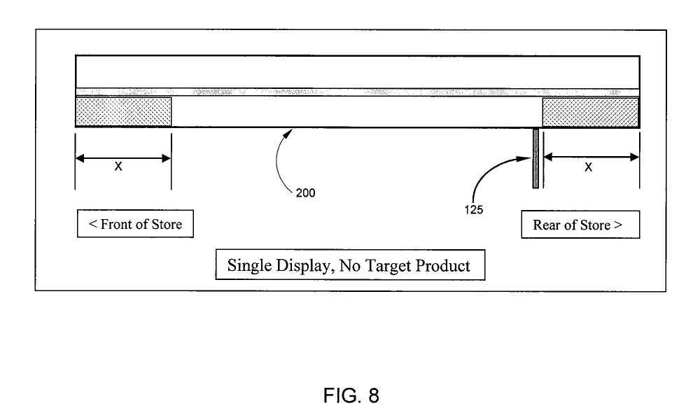

FIG. 8 illustrates the top view of a section of shelving 200 comprising a single video display 125, wherein there is no target product on the shelving 200. In such cases, FIG. 8 shows the preferred positioning of the video display 125 may be against one end of the end-of-aisle exclusion zone X, which is located towards the rear of the store. In theory, by placing the video display 125 in this manner, consumers navigating the store along the store perimeter may be enticed by the video display 125 to enter the aisle.

Video display 125 placement in aisles with multiple video displays 125 may follow the lateral placement parameters in a manner that is similar to the single video display 125 embodiments, with a few distinctions. In a typical embodiment of video display 125 placement in multiple display aisles, the end-of-aisle exclusion zones X and the target product positioning range(s) Z, if applicable, may be identified. Then, the first video display 125 may be disposed near the midpoint of the target product position range Z with the highest priority. The placement of the first video display 125 may establish a second exclusion zone, based on the minimum video display distance parameter Y. Next, if the section of shelving 200 is long enough to avoid overlap between the end-of-aisle exclusion zones X and the minimum-separation exclusion zones Y, a second and possibly a third video display may be disposed on the section of shelving 200. Additionally, to improve overall aisle coverage, it may be beneficial to maximize the distance between the video displays 125. FIG. 9, for instance, shows a basic example of a section of shelving with three video displays 125, 125′, and 125″, where the second 125′ and third 125′ video displays are positioned to maximize video display 125 separation.

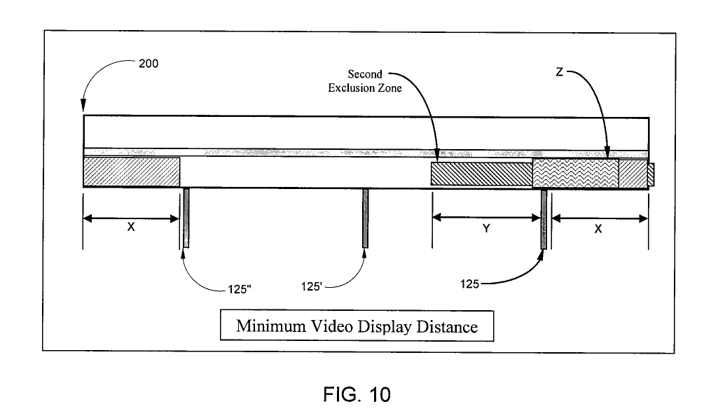

As with the single video display 125 example in FIG. 7, the placement of multiple video displays (e.g., 125, 125′, and 125″) may become distorted if the target product Z is stocked near the end of the aisle. For example, FIG. 10 illustrates one embodiment where a portion of the target product placement zone Z overlaps an end-of-aisle exclusion zone X. FIG. 10 shows that, in this embodiment, the first video display 125 may be shifted towards the aisle end. Then, FIG. 10 depicts that if there is sufficient room in the aisle, the second 125′ and the third 125″ video displays may be placed in the aisle, again maximizing the display 125 separation.

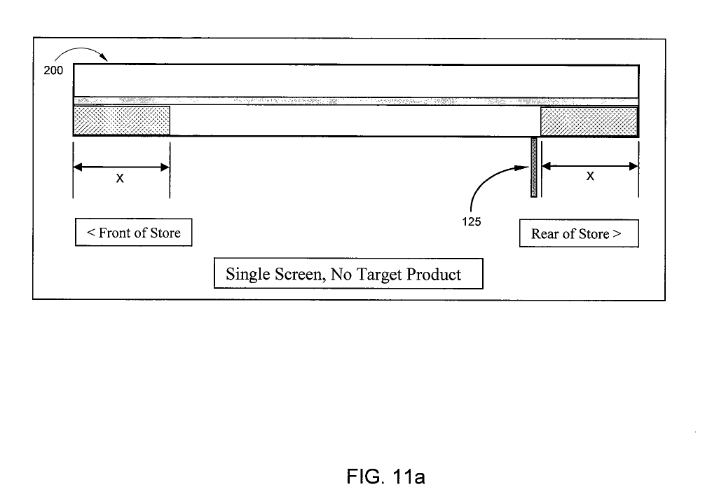

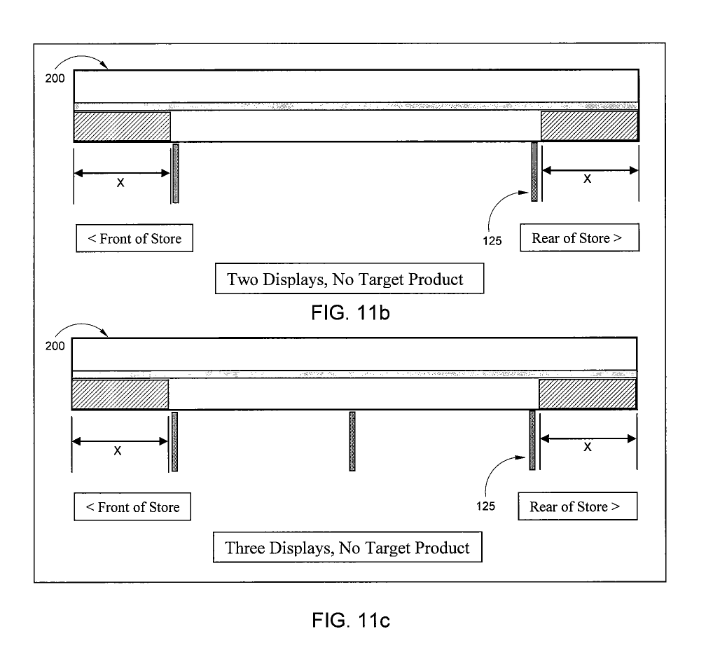

FIGS. 11a, 11b, and 11c illustrate how multiple video displays may be placed on a section of shelving 200 where there is no target product for sale in the aisle. For instance, FIG. 11a shows the first video display 125 placement may be as defined for single-video display 125 aisles, namely that first video display 125 may be placed near the edge of the aisle-end exclusion zone X, towards the rear of the store. FIG. 11b illustrates that in an aisle with two video displays 125 and 125′, the second display 125′ may be positioned as far from the first display 125 as possible, namely at the edge of the end-of-aisle exclusion zone X towards the front of the store. Finally, FIG. 11c shows that where a third video display 125″ is placed in the aisle, the third video display 125″ may be centered between the first 125 and second 125′ video displays.

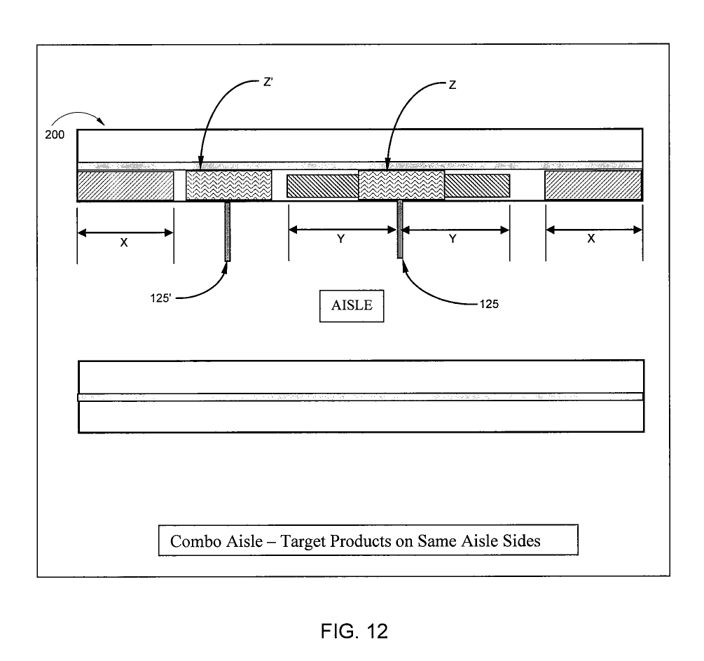

A combination aisle is an aisle in which multiple target products relate to multiple different channels. Generally, in combination aisles, the number of video displays 125 for the different channels may be added together to arrive at a new nominal video display count for the aisle, as long as that nominal video display count does not exceed three. For example, according to Table 1, combination aisles containing isotonic drinks and water may have a nominal video display count of 2. However, in combination aisles, the actual video display count installed in the aisle need not exclusively depend on the nominal video display count. Instead, the aforementioned lateral placement parameters that depend on aisle dimensions may still apply. For example, FIG. 12 illustrates the top view of a combination aisle with multiple target products Z and Z′, which are located on the same side of the aisle. In FIG. 12, the first video display 125 is located near the midpoint of the target product position range Z, or the product position range of the target product with the highest priority. Similarly, the second video display 125′ is placed near the midpoint of the target product position range Z′, or the product position range of the target product with a lower priority than the first target product. As previously mentioned, the various channels may also be prioritized in advance. The channels may then follow the same basic rules as those noted above for video display 125 placement. Moreover, in some embodiments, all screens for any given channel may display the same content at the same time or at different times, as desired.

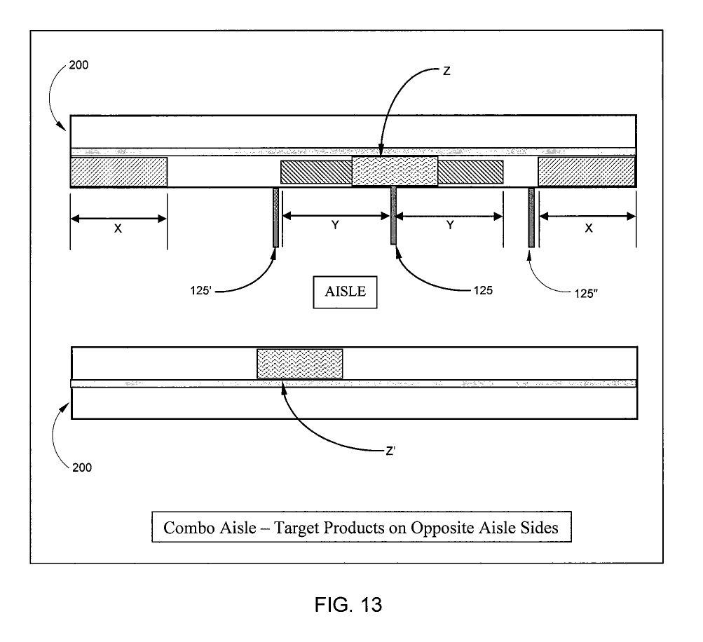

One issue that relates to combination aisles is the possibility that the different target product position ranges Y may sit on sections of shelving 200 that are on opposite sides of the aisle. In such embodiments, however, FIG. 13 illustrates the video displays (e.g., 125, 125′, and 125″) may be located on the same side of the aisle. Furthermore, each target product and target product position range (e.g., Z and Z′) may be given a priority order. Then, as FIG. 13 shows, the first video display 125 ma y be positioned relative to the highest-priority target product position range Z. Also, as shown in FIG. 13, the second video display 125′ may then be positioned as close as possible to the midpoint of the second-priority target product position range Z′, which means on the same side of the aisle as the first display 125, directly opposite (or as close as possible to directly opposite) the midpoint of the second-priority target product position range Z′. Finally, FIG. 13 illustrates, that a third video display 125″ may be placed near an end of the end-of-aisle exclusion zone X, in compliance with the lateral placement rules.

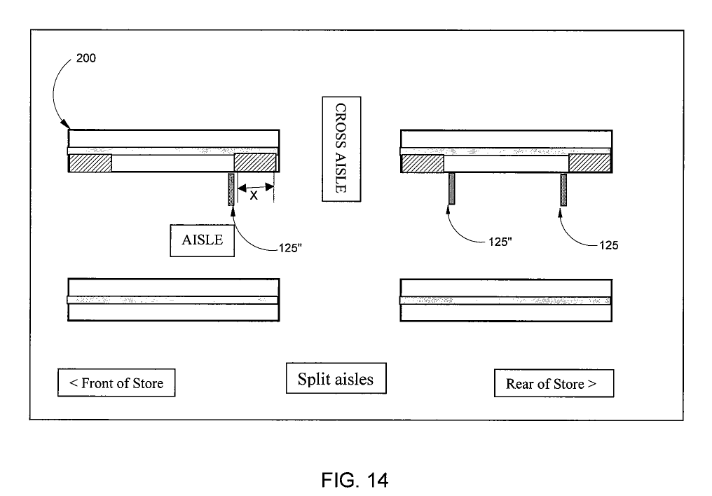

FIG. 14 illustrates one embodiment of a split aisle configuration, or an aisle with a cross-aisle dividing it, part way along its length. Particularly, FIG. 14 shows that where the sections of shelving 200 that are located near the rear of the store are at least 2X+Y in length, the rear split aisle shelving 200 may have two video displays 125 and 125′. Moreover, that Figure illustrates the front split aisle shelving 200 may have at least one video display 125″, where the video display 125″ is located towards the rear of the store but does not enter the end-of aisle exclusion zone X.

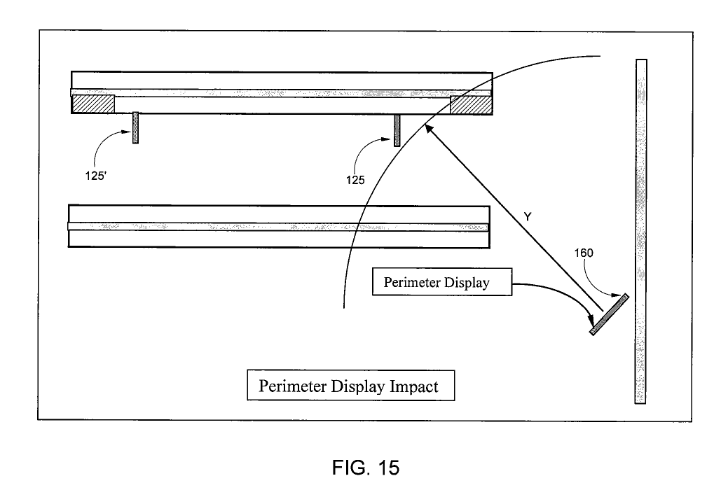

FIG. 15 illustrates one embodiment where a perimeter video display with one video screen 160 is used in conjunction with video displays 125 and 125′ located in aisles. In such embodiments, all video displays may be positioned outside the perimeter of the minimum video display distance. Of course, video displays 25 located in adjacent or parallel aisles may be closer to each other than the minimum video display distance Y would otherwise allow.

Having described the preferred aspects of the video display system and its associated methods, it is understood that the appended claims are not limited by particular details set forth in the above description, as many apparent variations thereof are possible without departing from the spirit or scope thereof.

TABLE 1

| | | Nominal | |
|---|---|---|---|
| Number | Channel | Screen Count | Target Products |
| 1 | Carbonated Soft Drinks | 3/2* | Diet Pepsi |
| 2 | Isotonic Drinks | 1 | Gatorade |
| 3 | Water | 1 | Aquafina |
| 4 | Salty Snacks | 3/2* | Doritos |
| 5 | Cereal | 3/2** | None |
| 6 | Cleaning | 1 | None |
| 7 | Health & Beauty | 2 | Tylenol |

1. An advertising video display system comprising:
a head-end cabinet comprising a server system;
a tail-end box comprising a line-driver device;
a line-driver box comprising a line-driver device;
a fin box;
a video display; and
a section of shelving, wherein, the head-end cabinet communicates with the tail-end box, wherein the tail-end box communicates with the line-driver box, wherein the line-driver box communicates with the fin box; wherein the fin box communicates with the video display; and wherein the video display is pivotally disposed perpendicular to a front edge of the section of shelving so the video display swings towards and away from the front edge of the shelving.

2. The advertising video display system of claim 1, wherein a lower edge of the video display is located between about 5 feet and about 5 feet 5 inches from the floor.

3. The advertising video display system of claim 1, wherein the video display is disposed outside of an end-of-aisle exclusion zone, and wherein the end-of-aisle exclusion zone is between about 3 feet and about 100 feet.

4. The advertising video display system of claim 3, wherein the end-of-aisle exclusion zone is about 8 feet.

5. The advertising video display system of claim 1, wherein the video display is disposed in an aisle and is not within a minimum video display distance of another video display disposed in the aisle, wherein the minimum video display distance is between about 10 feet and about 100 feet.

6. The advertising video display system of claim 1, wherein the video display is disposed in an aisle and is not within a minimum video display distance of another video display disposed in the aisle, wherein the minimum video display distance is about 28 feet.

7. The advertising video display system of claim 5, wherein the video display and the another video display in the aisle are each disposed on one side of the aisle.

8. The advertising video display system of claim 1, wherein the video display comprises padding disposed about a portion of a perimeter of the video display or a protective covering disposed over a video screen.

9. The advertising video display system of claim 1, wherein the tail-end box further comprises a computer, an audio receiver, or a transmitter.

10. The advertising video display system of claim 1, wherein the line-driver box further comprises a receiver.

11. A method of providing advertising in a retail environment, comprising:
providing an advertising video display system, comprising:
a head-end cabinet comprising a server system;
a tail-end box comprising a line-driver device;
a line-driver box comprising a line-driver device;
a fin box;
a video display; and
a section of gondola shelving, wherein, the head-end cabinet communicates with the tail-end box, wherein the tail-end box communicates with the line-driver box, wherein the line-driver box communicates with the fin box; wherein the fin box communicates with the video display; and wherein the video display is pivotally disposed perpendicular to a front edge of the section of shelving so the video display swings towards and away from the front edge of the shelving; and
presenting content on the video display near a target product.

12. The method of providing advertising in a retail environment of claim 11, further comprising the step of disposing the video display outside of an end-of-aisle exclusion zone, wherein the end-of-aisle exclusion zone is between about 3 feet and about 100 feet.

13. The method of providing advertising in a retail environment of claim 11, further comprising the step of disposing the video display outside of an end-of-aisle exclusion zone, wherein the end-of-aisle exclusion zone is between about 8 feet.

14. The method of providing advertising in a retail environment of claim 11, further comprising the step of disposing a lower edge of the video display between about 5 feet and about 5 feet 5 inches above the floor.

15. The method of providing advertising in a retail environment of claim 11, further comprising the step of disposing the video display so the video display is not within a minimum video display distance of another video display disposed in the same aisle, wherein the end-of-aisle exclusion zone is between about 3 feet and about 100 feet.

16. The method of providing advertising in a retail environment of claim 11, further comprising the step of disposing the video display so the video display is not within a minimum video display distance of another video display disposed in the same aisle, wherein the end-of-aisle exclusion zone is about 28 feet.

17. The method of providing advertising in a retail environment of claim 11, wherein the tail-end box further comprises a computer, an audio receiver, or a transmitter.

18. The method of providing advertising in a retail environment of claim 11, wherein the line-driver box further comprises a receiver.

19. The method of providing advertising in a retail environment of claim 11, wherein multiple video displays in an aisle are disposed according to a target product priority.

20. The method of providing advertising in a retail environment of claim 11, wherein the video display comprises padding disposed about a portion of a perimeter of the video display or a protective covering disposed over a video screen.
